(19) United States
(12) Patent Application Publication
(10) Pub. No.: US 2026/0300999 A1
(43) Pub. Date: Oct. 1, 2026

(54) SYSTEMS AND METHODS FOR ASSISTED CONTENT COMPLIANCE REVIEW OF DIGITAL CONTENT

(71) Applicant: Access Business Group International LLC, Ada, MI (US)

(72) Inventors: Jon A. Sherk, East Grand Rapids, MI (US); Ana Coppelia Sandford-Lopez, Grand Rapids, MI (US); Santiago Patlan, Grand Rapids, MI (US); Ken Popkin, Wyoming, MI (US); Marcio Balliet, Manton, MI (US); Ali Syed, Caledonia, MI (US)

(21) Appl. No.: 19/632,798

(22) Filed: Mar. 30, 2026

Related U.S. Application Data
(60) Provisional application No. 63/780,767, filed on Mar. 31, 2025.

(51) Int. Cl. G06Q 30/018; G06F 16/34; G06F 40/58

(52) U.S. Cl. CPC G06Q 30/018; G06F 16/345; G06F 40/58

(57) ABSTRACT

A system and method for assisted content compliance review of digital content—including audio, video, and multimedia files using machine learning models integrated with structured human review workflows. A content submission portal stores uploaded content and metadata. A content compliance processing system automatically identifies potential compliance violations via transcription, classification, translation, and summarization models. A reviewer interface presents violations for validation and feedback, while a reviewer-in-the-loop framework enables model retraining over time. In some embodiments, a self-help interface provides content creators with pre-submission compliance guidance and revision tools. Compliance results are communicated via a compliance enforcement system using predefined templates or automated actions. The architecture supports scalable review workflows, hierarchical violation classification, and prioritization based on confidence scores, transforming traditional compliance review into an assistive, feedback-driven, and scalable system.

### BACKGROUND OF THE INVENTION

The present disclosure relates to systems and methods for reviewing digital content for content compliance, and more particularly to improving workflows associated with reviewing user-submitted media files, including audio, video, and multimedia content, to determine adherence to applicable compliance rules or standards.

Conventional content compliance workflows rely heavily on fragmented, manual processes. Submissions are often received through email or ad hoc file transfer mechanisms, and may include audio or video recordings created by affiliates, content creators, or other users. To prepare such content for review, content compliance review personnel must typically upload media files to separate third-party transcription tools to convert audio to text. Independently, internal tracking systems often require reviewers to create workflow records manually and attach relevant files and metadata.

Once transcription is complete, reviewers must manually listen to the content in real-time, identify and record potential compliance issues, and separately document these issues in free-form formats such as email or word processing documents. These findings must then be re-entered into workflow platforms, sometimes in duplicate, to preserve institutional records. In some cases, content creators do not receive feedback until long after submission, if at all, and there is little or no opportunity to receive preliminary automated feedback prior to formal compliance review.

This legacy approach presents several challenges: (i) reliance on disconnected software systems lacking native integration; (ii) extensive manual effort required to prepare, review, and track submissions; (iii) elevated risk of human error due to redundant data entry and unstructured documentation; and (iv) inconsistent behavior of review platforms, such as failures in file attachment processes that are not immediately detectable by reviewers.

Accordingly, there remains a need for improved systems and methods that reduce the burden on compliance reviewers and improve the reliability, consistency, and traceability of content compliance outcomes. In particular, enhancements are needed in the way content is received, processed, and reviewed, including improved support for handling multimedia content and for providing reviewers with tools that facilitate more efficient and accurate evaluations within established compliance frameworks.

In addition to inefficiencies in internal reviewer workflows, current systems often lack user-facing tools that enable content creators to obtain timely, automated feedback about potential compliance concerns prior to formal submission. A scalable solution capable of multilingual, multi-modal automated analysis—including audio, video, text, and visual content—remains an unmet need in the industry. Systems operating across varied content formats and supporting international compliance frameworks are particularly needed to improve content quality at the source and reduce review backlog.

### SUMMARY OF THE INVENTION

The present disclosure relates to a system and method for assisted content compliance review of digital content. The system is designed to assist human reviewers and content creators by automatically identifying potential content compliance violations in submitted materials—including audio, video, multimedia, and text content—via a unified review pipeline. The system is applicable to a range of content types and sources, including business support materials, marketing and sales content, and content from digital platforms such as social media and livestreams. A content submission portal receives and stores uploaded digital content and metadata in any supported language and format. The content compliance processing system leverages a plurality of processing models—such as transcription, classification, translation, summarization, visual recognition, and sentiment analysis—against a proprietary, curated ground truth dataset that defines compliance standards across markets.

To streamline and support the reviewer experience, the system includes a reviewer interface configured to present automatically generated content compliance violations alongside corresponding transcribed text. The interface enables reviewers to confirm or reject flagged violations, provide narrative feedback explaining their determinations, and manually annotate portions of the transcribed content with newly identified violations. Reviewer feedback is stored in a reviewer feedback system and may be used to refine classification structures and improve model performance through retraining. This reviewer-in-the-loop feedback loop enhances the assistive nature of the system by improving accuracy while maintaining reviewer control.

Violations and results are communicated to content submitters through a compliance enforcement system, which may utilize predefined communication templates or trigger automated enforcement actions based on review outcomes. The system further supports rule classification using a hierarchical structure comprising multiple classification levels, such as higher-level thematic categories (e.g., provider positioning or business building), middle-level groupings (e.g., prospecting or time commitment), and lower-level granular business rule compliance classifications derived from organization-specific policies. These may include, for example, non-optional classification, unsubstantiated product performance classification, misleading promotional claim classification, or extraordinary earning classification to name a few examples.

The system supports scalable deployment using machine learning models hosted in a cloud-based platform and includes application programming interfaces (APIs) and microservices to facilitate modular execution of processing tasks. Models may operate on cloud-based content stores and return results to a content compliance processor for aggregation and presentation. Historical compliance review outcomes and associated reviewer feedback may be retained in a compliance data repository to support trend analysis, auditability, and refinement of content compliance rules and model logic over time. Confidence measurements and ranking algorithms associated with automatically generated content compliance violations may be used to prioritize reviewer attention based on classification certainty.

In some embodiments, the system includes a self-help capability that provides submitters with preliminary, automated feedback on potential compliance concerns before submission for formal review. In addition, the system may support AI-assisted content creation workflows that incorporate compliance-aware suggestions during drafting or editing, such as guidance aligned with the ground truth dataset.

By integrating automated violation detection with structured reviewer interaction and feedback, the system improves both the efficiency and accuracy of content compliance workflows. This approach reduces manual review burden, increases consistency in identifying violations, and empowers reviewers with contextual tools such as summarization and sentiment indicators. The architecture is adaptable to high-volume content environments, supports multilingual and localized review, and facilitates continuous improvement of compliance models based on actual reviewer input. These features collectively transform the compliance review process from a segmented, manual task to a guided, assisted workflow that scales with organizational needs.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

The drawings accompanying the present disclosure illustrate various embodiments of the systems and methods for assisted content compliance review of digital content. The figures are presented for illustrative purposes and are not intended to be limiting.

FIG. 1 is flowchart illustrating one embodiment of a process for processing digital content and providing assisted content compliance review.

FIG. 2 is a block diagram illustrating an overall system architecture for processing digital content submitted for content compliance review.

FIG. 3 is a schematic representation of content compliance processing models and supporting systems used to perform artificial intelligence-assisted analysis of digital content.

FIGS. 4A-4C illustrate an example of a content submission portal user interface for uploading digital content and entering associated user-supplied metadata.

FIG. 5 illustrates a portion of a digital content compliance review assistance user interface, showing compliance review statuses and results for submitted digital content.

FIG. 6 illustrates another portion of the digital content compliance review assistance user interface, highlighting submission details and an artificial intelligence-generated summary of the digital content.

FIG. 7 illustrates another portion of the user interface, highlighting artificial intelligence-generated transcription and content compliance violations automatically identified by the system.

FIG. 8 illustrates a transcription tracking feature of the digital content compliance review assistance user interface, enabling reviewers to efficiently understand and navigate the portions of content associated with identified content compliance violations.

FIG. 9 illustrates a portion of the user interface emphasizing potential content compliance violations and classification groupings generated by the content compliance processing system.

FIG. 10 illustrates a pop-up interface for manually associating a content compliance violation with a reviewer-selected portion of the transcribed content.

FIG. 11 illustrates a further portion of the digital content compliance review assistance user interface showing a template-guided communication workflow for notifying content submitters of content compliance violations.

FIG. 12 illustrates an example rejection template for communicating the results of a content compliance review to a content submitter.

### DETAILED DESCRIPTION OF THE CURRENT EMBODIMENTS

The systems and methods described herein enable assisted content compliance review of digital content by integrating artificial intelligence tools with structured reviewer interaction. These systems support the submission, processing, review, and enforcement of compliance determinations for audio, video, or multimedia content. The invention improves upon conventional workflows by automating key portions of the compliance review process—such as transcription, classification, and rule-based flagging—while maintaining human oversight through an intuitive reviewer interface. In the following description, reference is made to various embodiments and system components, including illustrative user interfaces, data storage systems, and AI-assisted processing pipelines.

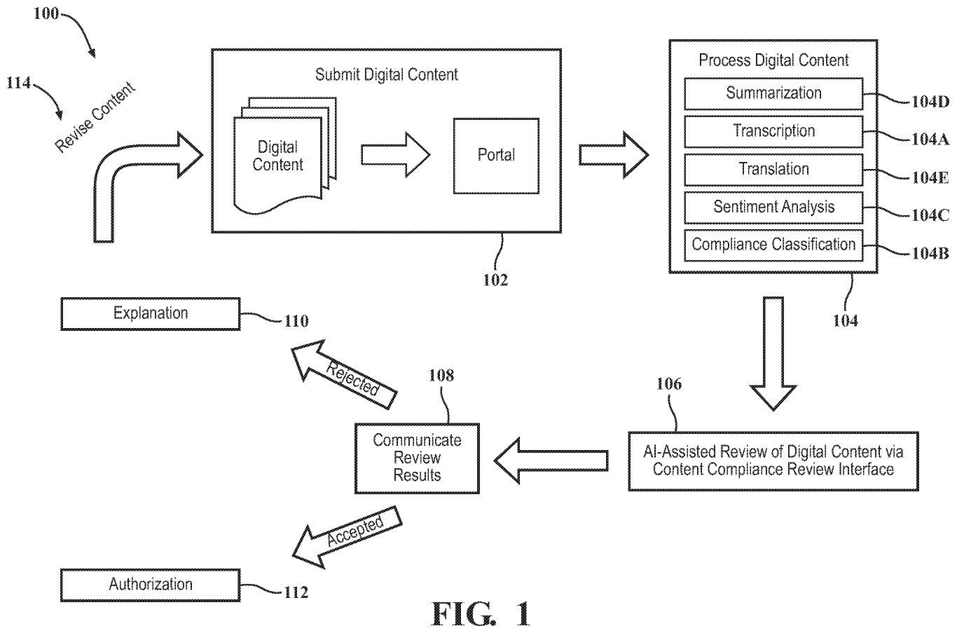

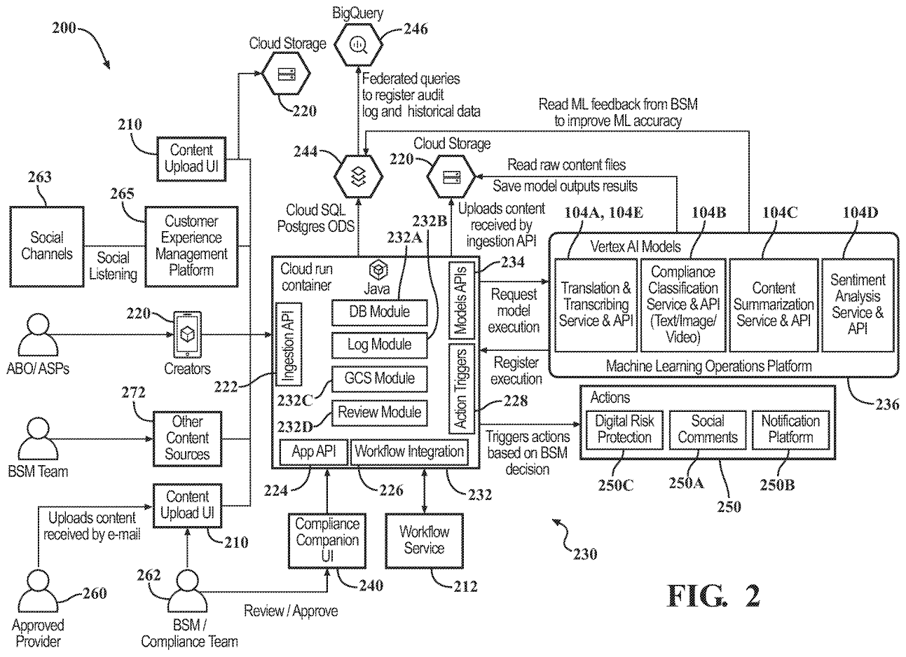

Referring now to FIG. 1, an exemplary process flow 100 for assisted content compliance review of digital content is illustrated. The system architecture is designed to assist human reviewers by automating the identification of potential content compliance violations and presenting those violations in a streamlined review interface. The process begins with a content submission step 102, where users such as advisors or content creators submit digital content through a content submission portal (see portal 210 in FIG. 2). This portal may be implemented using a web-based form or workflow management tool configured to receive audio, video, or multimedia content.

Upon submission, the content and associated metadata are stored in a storage system (see storage system 220 in FIG. 2), such as a cloud-based storage repository. This may include a combination of object storage for raw media content and a structured database for metadata and submission records. Once stored, a content compliance processing system (see processing system 230 in FIG. 2) accesses the content and initiates an automated review process (step 104).

The content compliance processing system includes a content compliance processor (see processor 232 in FIG. 2), which orchestrates a plurality of machine learning models to analyze the digital content. These models include: a transcription model 104A configured to convert audio or video content into a text-based format; a content compliance detection model 104B configured to identify potential content compliance violations; a sentiment analysis model 104C; a summarization model 104D; and a translation model 104E, depending on the embodiment. Model execution may occur through a cloud-based execution environment, with orchestration handled via containerized components and model requests dispatched via an application programming interface (API) or micro-service.

The resulting transcribed content and identified violations are passed to a reviewer interface (see interface 240 in FIG. 2) for AI-assisted review (step 106). The reviewer interface is configured to display the transcribed content alongside automatically identified content compliance violations. Reviewers can confirm or reject these violations via selectable interface elements and provide narrative comments where appropriate. The interface also supports manual tagging of violations, including a pop-up annotation tool for selecting specific portions of transcribed content.

Reviewer input is captured and written back to a reviewer feedback system (see reviewer feedback system 232D in FIG. 2) and may be persisted in a relational database or forwarded to a long-term data warehouse (see data repository 244 in FIG. 2) for trend analysis and model refinement. In some embodiments, feedback from confirmed or rejected violations is used to retrain the classification and detection models, improving accuracy over time.

Upon completion of the review process, results are communicated to the content submitters through a compliance enforcement system (step 108; see enforcement system 250 in FIG. 2). The enforcement system may generate notifications via email and utilize predefined communication templates or trigger rule-based enforcement actions. Explanation interfaces 110 may be presented to justify rejections, and acceptance may lead to authorization step 112. Compliance review results are stored alongside historical records for future audits and analytics.

In some embodiments, if content is rejected, the system may enable submitters to revise and resubmit the digital content (step 114), thereby reinitiating the review cycle. FIG. 1 therefore provides a high-level overview of an integrated architecture that enables assisted content compliance review, streamlining previously manual workflows and enhancing the consistency, traceability, and scalability of the review process through structured AI integration and reviewer interaction.

Referring now to FIG. 2, a system-level architecture 200 is shown that illustrates the various software components, user devices, and cloud-based infrastructure used to implement one embodiment of the assisted content compliance review process. The system includes a content submission portal 210, which may be accessed by multiple types of user devices. These include approved provider devices 260, business support material/compliance team devices 262, creator devices 270 (e.g., devices used by select business owners or service providers), and other content source devices 272. Each of these devices can be configured to initiate content submissions through a web-based interface or workflow tool. In some implementations, select devices may bypass the content submission portal 210 and submit content directly to the ingestion application programming interface (API) 222. The content submission portal 210 interacts with an ingestion API 222, which handles intake of submitted content and associated metadata. The ingestion API 222 is responsible for uploading the digital content and metadata to a cloud-based storage system 220, which may include object storage and structured storage such as a relational database. Content may be uploaded by users via a suitable content upload interface or similar workflow platform.

Submitted content is then accessed by a content compliance processing system 230, which includes a centralized or distributed content compliance processor 232. The processor comprises a plurality of modular services responsible for data processing and orchestration of machine learning models. In the illustrated embodiment, the processor 232 is implemented in a containerized environment and includes at least four modules: a database module 232A configured to manage structured metadata and reviewer inputs, a log module 232B configured to capture system events and audit trails, a cloud storage module 232C configured to interface with remote content repositories, and a reviewer feedback system module 232D configured to receive and manage human review inputs. These modules collectively can coordinate content access, model execution, and review data handling throughout the compliance evaluation process. Although specific modules are shown and described, it will be understood that additional, fewer, or alternative modules may be used, and the functionality attributed to each module may be distributed across multiple components or consolidated into fewer components in other embodiments.

The processor 232 interacts with multiple application programming interfaces (APIs) and microservices to facilitate system integration, orchestration, and model execution. In the illustrated embodiment, these include a workflow integration interface 226 configured for bidirectional communication with external workflow management tools; a model execution API 234 configured to send requests to, and receive responses from, one or more machine learning model execution environments (e.g., cloud-based AI services); and an action trigger API 228 configured to initiate downstream compliance enforcement actions via the compliance enforcement system 250. The model execution API 234 may be used to invoke various content analysis models, including transcription, classification, sentiment analysis, summarization, and translation models. Although specific APIs are depicted and described, the system may include additional or alternative APIs for handling other types of integration, service orchestration, or model invocation depending on the implementation.

A machine learning model execution environment 236 accesses raw content files from cloud storage 220, processes the data using one or more content analysis models, and returns the resulting outputs to the processor 232. These outputs may include, for example, transcribed text, translated text, summarization text, content compliance classification indicators, sentiment scores, or other model-derived metadata. In some embodiments, reviewer feedback collected during the assisted review process may be written to a structured data repository 244, such as a cloud-hosted relational database, to serve as training input for future versions of the models. This repository 244 may also support federated querying or data export to an analytics system 246, such as a cloud-based data warehouse, to facilitate long-term reporting, trend analysis, and audit logging. While specific data storage and processing platforms may be used in various implementations, the architecture is adaptable to a variety of cloud-based or hybrid infrastructure environments.

Social media platforms 263 and social monitoring or listening services 265 may interface with the ingestion API 222 to submit digital content for analysis or to extract insights relevant to content compliance. Additionally, other internal or enterprise-managed content sources 272 may be configured to submit digital content through the same ingestion interface. These internal sources may include marketing teams, communications departments, or other business units producing promotional or sales-related content intended for public or regulated distribution. These sources may include systems used by compliance, marketing, or content governance teams, and may include previously distributed materials or internally generated digital assets. In some embodiments, such content may be automatically queued for review based on metadata attributes, content origin, or associated business rules. The ingestion API 222 may support various input formats and authorization mechanisms to accommodate diverse integration scenarios across external and internal systems.

After content has been processed and reviewed, the system generates compliance enforcement results via the compliance enforcement system 250. The enforcement system may implement predefined communication templates, automated rule-based actions, or both. Enforcement actions may be executed through a variety of service integrations, including but not limited to social media moderation tools 250A, email-based notification services 250B, and external content monitoring or takedown services 250C. For example, email notifications may be sent using third-party transactional messaging services, and brand or policy enforcement may be facilitated through integration with external platforms that support content flagging, removal, or reporting. These components may be implemented using any suitable notification or digital risk protection tools, depending on the deployment environment and enforcement objectives.

The reviewer interface 240 enables human reviewers to interact with AI-generated content compliance data and transcribed digital content. The interface is operably connected to the content compliance processor 232 via an application-facing application programming interface (API) 224. Through this interface 240, reviewers may confirm, reject, or supplement identified content compliance violations, as well as review summaries, sentiment indicators, and other contextual model outputs. The reviewer interface may include interactive elements such as a pop-up annotation tool, which allows reviewers to highlight specific portions of the transcribed content and manually associate them with new or revised content compliance violations. Reviewer inputs are written to the reviewer feedback system 232D and may be logged in structured form to support downstream analytics or machine learning workflows. In certain embodiments, this feedback loop is used to refine the behavior of compliance classification models, enabling adaptive and reviewer-informed improvement in system performance over time.

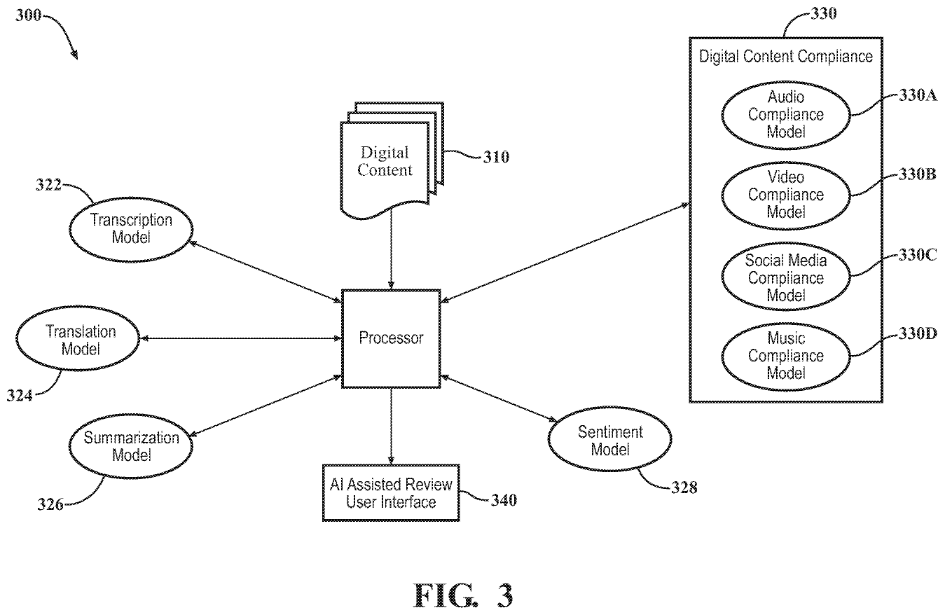

While FIG. 1 illustrates one embodiment of a high-level content compliance assistance process flow and FIG. 2 details one embodiment of a content compliance assistance system-level architecture, FIG. 3 presents a modular architectural view of a content compliance processor and its associated model orchestration framework. In particular, FIG. 3 illustrates the internal structure of one embodiment of the content compliance processing system 230, emphasizing how various models can interact with the processor to produce AI-assisted compliance outputs.

As shown, the processor 320 is configured to receive digital content 310 from one or more content sources, such as those submitted through the content submission portal 210 or the ingestion API 222. Upon receipt of the digital content 310, the processor 320 initiates communication with a plurality of machine learning models, each configured to perform a distinct form of content analysis. In the illustrated embodiment, these models may include a transcription model 322, a translation model 324, a summarization model 326, a sentiment analysis model 328, and one or more digital content compliance models 330. The processor 320 may communicate bidirectionally with each model to transmit data for inference and receive corresponding output for aggregation and downstream processing.

The digital content compliance model 330 may serve as a container or orchestration layer for one or more specialized sub-models configured to evaluate different media modalities, content types, or compliance criteria. As illustrated in FIG. 3, the digital content compliance model 330 may include, by way of example, an audio compliance model 330A, a video compliance model 330B, a social media compliance model 330C, and a music compliance model 330D. Each of these sub-models may be independently trained and optimized to detect potential compliance violations in content corresponding to its respective domain. In some embodiments, additional or alternative sub-models may be included, such as text compliance models, image-based content analysis models, or region-specific compliance classifiers. The sub-models may be invoked independently, sequentially, or in parallel, depending on the format, language, or origin of the submitted digital content and the applicable compliance ruleset.

Once the content has been processed by the various models, the aggregated results are returned to the processor 320. The processor then routes the structured outputs—such as transcribed text, sentiment classifications, summaries, translations, and compliance flags—to the reviewer interface 340. The reviewer interface provides an integrated workspace for human reviewers to validate, reject, or supplement the automatically identified content compliance violations. This flow reinforces the assistive nature of the invention by enabling machine learning outputs to streamline human decision-making without replacing human judgment.

In some embodiments, the reviewer interface 340 is further configured to transmit reviewer input—such as confirmation, rejection, or annotation of content compliance violations—back to the processor 320. These reviewer actions can be captured live (e.g., in real-time or near real-time) and associated with specific content segments, timestamps, or model-generated classifications. In certain implementations, this enables a dynamic feedback loop between the human reviewer and the content compliance processor, allowing for interactive refinement of model outputs during review. In other implementations, reviewer feedback may be collected and stored for asynchronous processing, such as offline analysis, model retraining, or periodic deployment of updated models. This flexibility supports both live and batch-based workflows, enhancing traceability and explainability within the compliance review process.

Reviewer inputs may also be stored in structured formats that facilitate downstream analytics and machine learning refinement. For example, reviewer-confirmed violations may be labeled as true positives and reviewer-rejected outputs may be treated as false positives for purposes of supervised learning. Additionally, reviewers may provide narrative rationale or context associated with their determinations, which may be parsed or referenced in future model training cycles. Over time, this reviewer-in-the-loop configuration enables adaptive improvements to model accuracy and decision boundaries, ensuring that the system aligns more closely with evolving compliance standards and institutional review practices.

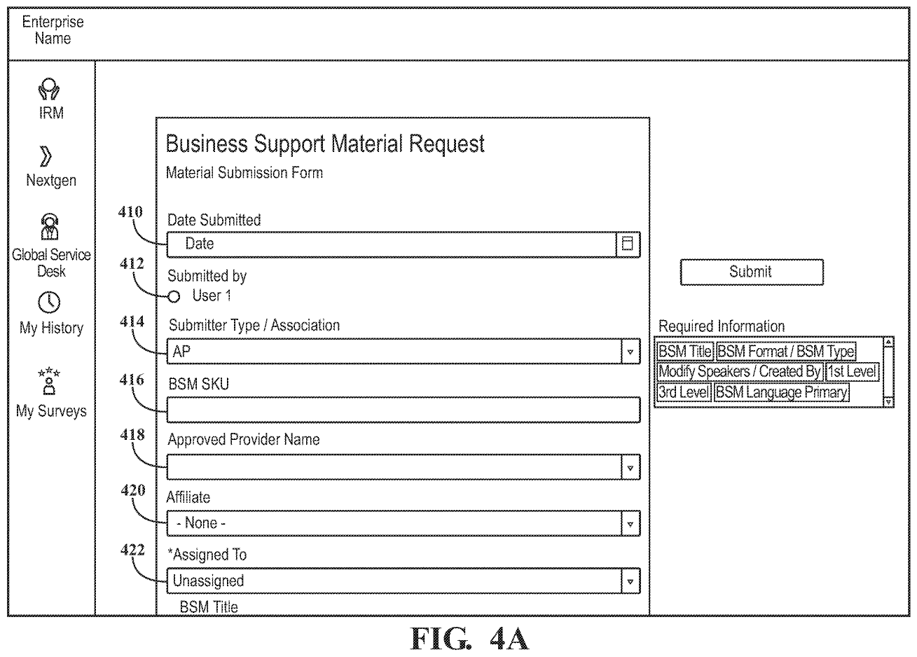

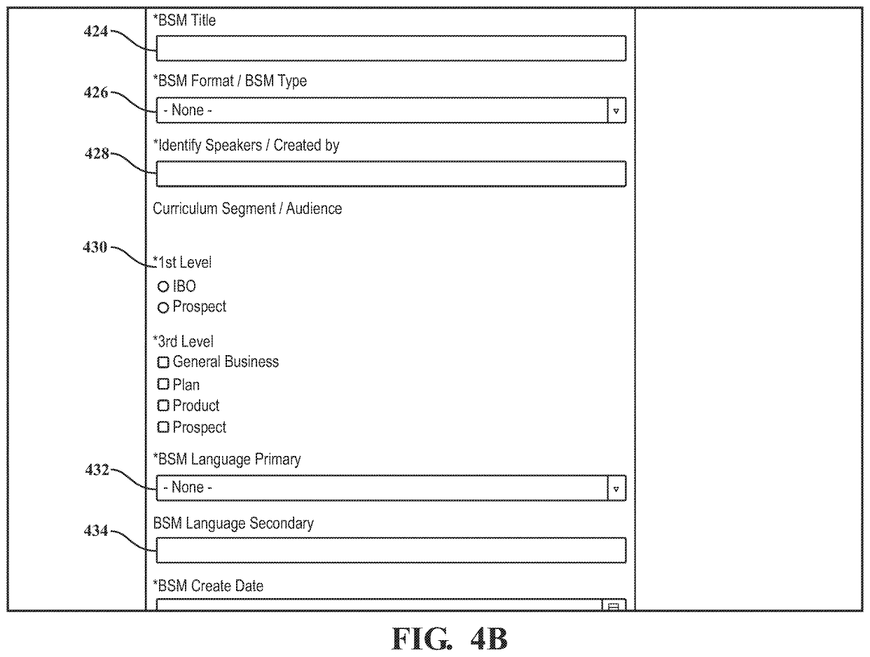

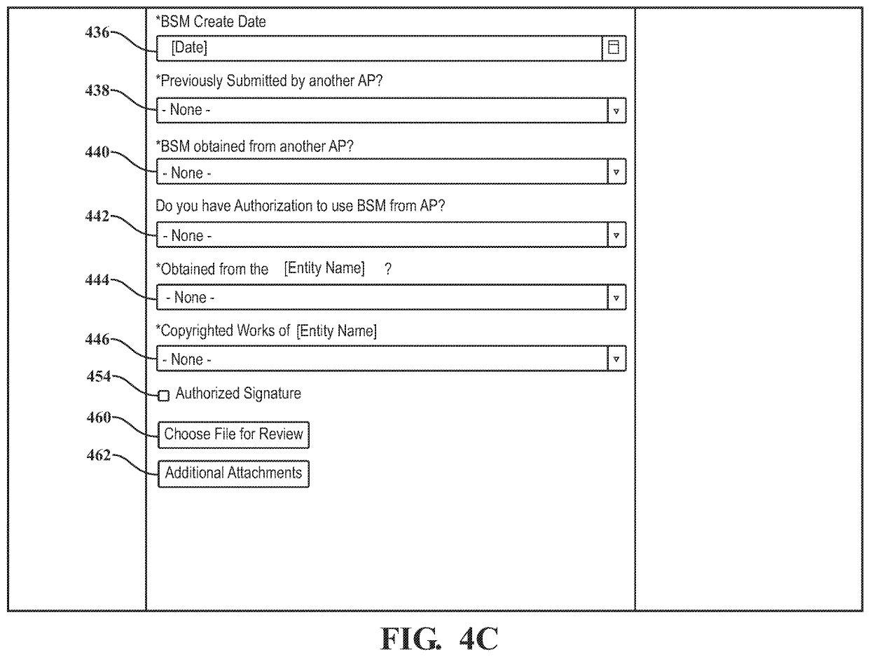

FIGS. 4A-4C illustrate one embodiment of a content submission interface provided through the content submission portal 210. In this embodiment, the content submission portal is a web-based user interface configured to collect submission information and to initiate a content compliance review request. This interface may be referred to in some implementations as a business support material (BSM) request form, although the specific terminology and data fields may vary depending on deployment context or organizational standards.

As shown in FIG. 4A, the interface includes fields for identifying core submission metadata. These fields may include, for example, the date of request 410, the submitter's name 412, the submitter's type or organizational affiliation 414 (e.g., independent business owner, approved provider, or internal compliance staff), the BSM SKU (stock keeping unit) 416, the name of the associated approved provider 418, any associated affiliate entity 420, and the individual to whom the submission is assigned for review 422. This structured metadata allows the system to associate the submitted content with relevant business and organizational context, enabling traceability and workflow assignment. In some embodiments, the assignment field 422 may be auto-populated based on organizational rules or routed via the workflow integration interface 226 described above.

FIG. 4B illustrates additional metadata input fields that capture information relating to the nature and intended use of the submitted business support material. These fields may include the BSM title 424, the BSM format or content type 426 (e.g., audio, video, multimedia, PDF), and the identification of individuals featured or heard in the content 428—such as presenters, speakers, or content creators. This information may be used by the system for indexing, content classification, or for informing reviewer expectations. Additionally, this portion of the interface may include audience targeting fields 430 that identify the primary curriculum segment or intended audience for the content, such as whether the material is directed toward independent business owners (IBOs), prospects, or other third parties. In some implementations, users may also identify a third-level category within field 430 such as general business, product-specific content, opportunity plan presentations, or prospecting material. These labels may inform downstream processing logic, such as determining applicable compliance rulesets or routing the submission for specialized review.

Further, the form may request language metadata, such as a primary BSM language 432 and a secondary BSM language 434. This information may be used by the translation model to determine whether multilingual processing should occur or whether content should be routed to a multilingual reviewer. In some implementations, this language metadata may also affect which summarization or classification models are invoked during content analysis.

FIG. 4C shows a final portion of the interface focused on content provenance and authorization details. These fields may include the BSM creation date 436 and a series of checkboxes or prompts such as: whether the content was previously submitted by another approved provider 438, whether the material was obtained from another approved provider 440, and whether the submitter has obtained the necessary authorization to reuse or redistribute the content 442. Additional fields may include an enterprise origin indicator 444 and a checkbox 446 to indicate whether any enterprise-owned copyrighted works are included in the content. These provenance and authorization fields may be used for recordkeeping, auditability, or to trigger automated logic for additional review depending on the origin of the content.

In some embodiments, the interface may include an affirmative confirmation mechanism, such as an authorized signature checkbox 454 to verify that the submitter has reviewed and affirmed the content submission and accompanying representations. This may operate as a digital acknowledgment.

At the bottom of the interface, one or more upload interface elements allow the user to attach the digital content files to be reviewed. This may include a primary file upload control 460 to attach the substantive business support material as well as an additional attachments interface 462 for uploading supplementary materials, such as authorization letters, prior approvals, or related correspondence. The upload interface may support drag-and-drop interfaces, file pickers, or direct cloud integrations, and may enforce restrictions on file formats or size limits. Upon submission, the content and metadata are transmitted through the ingestion API 222 and stored in the cloud storage system 220 for processing by the content compliance system 230.

Although the illustrated embodiment captures a particular layout and set of metadata fields, it should be understood that the submission portal 210 may be implemented using alternative forms, dynamic user interfaces, or integration with existing content management systems. The number and type of metadata fields may vary, and the portal may be adapted to support different languages, regional compliance frameworks, or enterprise branding. In some embodiments, the form may auto-populate certain fields using user authentication profiles, and in others, conditional logic may guide the user through the form depending on prior responses. These dynamic and extensible features enable scalable deployment of the system while ensuring consistent intake of structured submission metadata across various user groups.

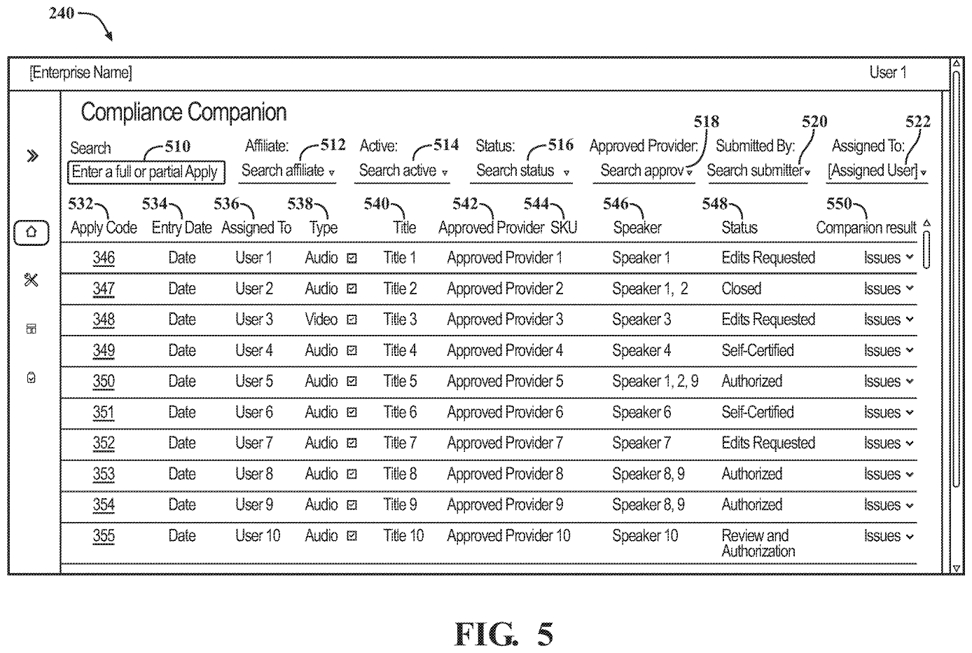

Referring now to FIG. 5, an example of a reviewer interface 240 is shown. In the illustrated embodiment, the reviewer interface 240 is implemented as a web-based application, such as a single-page application developed using a component-based framework (e.g., React), and serves as the primary interface through which compliance reviewers interact with submitted digital content. The interface functions as a centralized workspace for navigating, filtering, and managing content compliance submissions.

As depicted in FIG. 5, the interface includes a search bar 510 configured to permit keyword-based search across available submissions. Adjacent the search bar, a set of filter controls enable reviewers to constrain the view based on various metadata fields, including but not limited to: affiliate 512, submission status 514, active indicator 516, approved provider 518, submitter identity 520, and reviewer assignment 522. These filter elements may be implemented using dropdown selectors, multiselect, or other interactive components designed to facilitate rapid navigation through a large volume of reviewable items.

The main panel of the interface displays a tabular, spreadsheet-style view 530 of the submissions, with each row corresponding to an individual submission entry and each column representing a metadata field or system-generated attribute. In the illustrated embodiment, the columns include fields such as apply code 532, entry date 534, assigned reviewer 536, content type 538, BSM title 540, approved provider name 542, SKU 544, speaker name 546, submission status 548, and comparison result 550. These fields enable the reviewer to assess submission scope, status, and assignment at a glance and to identify priority submissions for deeper inspection.

The reviewer interface 240 may be configured to allow a reviewer to click on any row within the table to drill down into the full submission details, including model-generated transcriptions, content compliance flags, and review history. In some embodiments, this landing page may include dynamic sorting, pagination, and visual cues (e.g., color-coded indicators) to highlight submissions that are overdue, recently updated, or pending additional reviewer action. In still further embodiments, the interface may allow users to export submission lists, generate summary reports, or bookmark specific submissions for future reference.

Although FIG. 5 illustrates a particular layout and set of filterable attributes, the reviewer interface 240 may be customized or reconfigured in alternative implementations to support different organizational roles, review workflows, or regulatory requirements. For example, additional filters or display fields may be included to account for localization, language attributes, submission channel, or AI confidence scores. The interface is further adaptable to mobile, desktop, or tablet environments, enabling reviewer access across a wide range of devices.

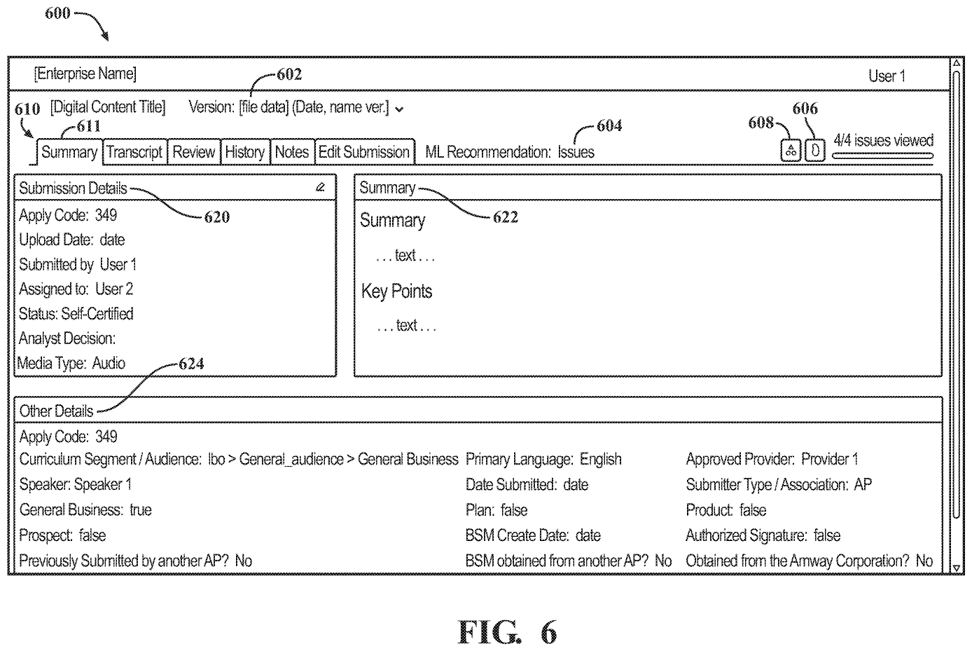

Referring now to FIG. 6, a screenshot of one embodiment of a detailed reviewer interface view 600 is illustrated. This view may be accessed by selecting a submission entry from the reviewer interface landing page (FIG. 5) and is configured to display submission-specific information across multiple organized panels and tabs. In the depicted embodiment, the interface 600 presents metadata, content summaries, reviewer tools, and machine learning insights in a structured layout designed to facilitate efficient review and traceability.

At the top of the reviewer interface 600, a submission header 602 is displayed, which includes the digital content title, the most recent version of the associated file, and a version control dropdown. In some embodiments, the version dropdown allows the reviewer to toggle between historical versions of the digital content, each associated with a separate time-frozen review state. The header also displays a machine learning recommendation indicator 604 (e.g., “Issues”), a paperclip icon 606 for accessing supplemental attachments, and a download icon 608 for retrieving the source file under review. The header may further include a progress indicator showing the number of identified issues and the number reviewed, providing high-level insight into review completion.

A tabular navigation bar 610 is positioned below the header and allows the reviewer to toggle between different review views. In the illustrated embodiment, the available tabs include: a summary tab 611 (active in FIG. 6), a transcript tab, a review tab, a history tab, a notes tab, and an edit submission tab. These tabs provide access to various stages of the review workflow and are configured to present context-specific data and reviewer actions relevant to each stage.

The main body of the reviewer interface 600 includes a series of data panels, each configured to present relevant metadata or analytical outputs. These include a submission details panel 620, a content summary panel 622, and an other metadata panel 624. The submission details panel 620 presents a high-level summary of the submission, including fields such as apply code, upload date, submitter identity, assignee identity, content status, analyst decision (if applicable), and media type. In some embodiments, this panel includes an inline edit control that enables reviewers or administrators to update these fields without leaving the view.

The content summary panel 622 provides a machine-generated summary of the digital content, which may be derived from use of a combination of transcription and summarization models. In the illustrated embodiment, this panel also displays a set of key points extracted from the content, formatted as bulleted highlights. These summaries and highlights assist reviewers in quickly understanding the general substance and tone of the submission without full playback of the digital content.

The other metadata panel 624 consolidates additional structured metadata fields related to audience targeting, content origin, speaker identity, submission history, and authorization attributes. Examples may include curriculum segment, speaker name, primary language, date submitted, whether the content was obtained from another provider, or whether appropriate permissions have been certified. This metadata may be populated via the submission portal 210 (FIGS. 4A-4C) and is presented here to provide the reviewer with context to interpret and validate the content in view of compliance criteria.

Although specific panels and metadata fields are shown in FIG. 6, alternative embodiments may include additional, fewer, or different panels depending on deployment context, user role, or institutional preferences. In some cases, dynamic forms or configurable layout templates may be used to tailor the interface to individual reviewer preferences or regional compliance obligations. These interface elements may also be rendered responsively to support viewing on a range of devices, including desktops, tablets, and mobile platforms.

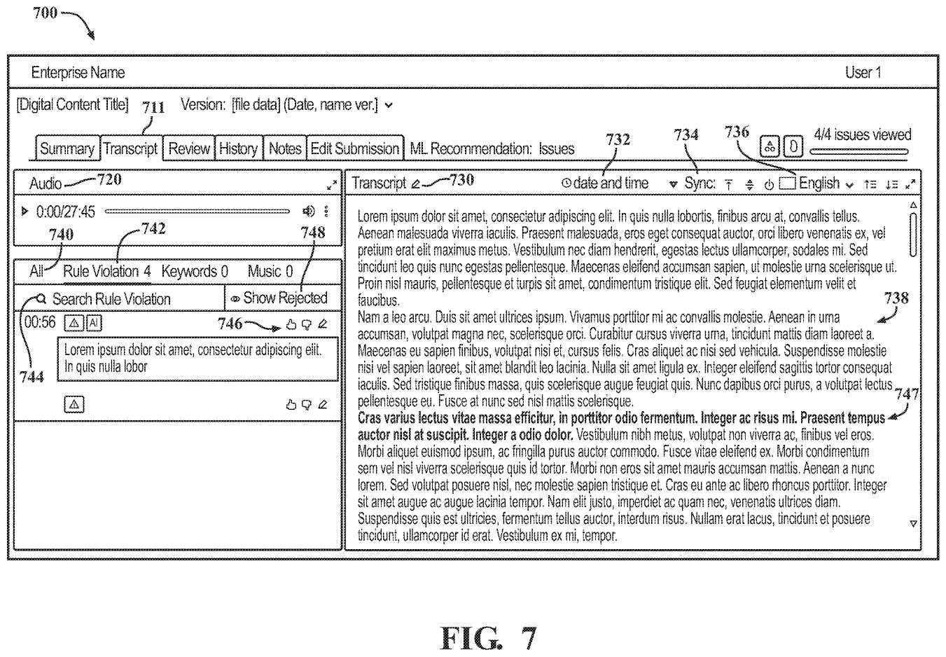

Referring now to FIG. 7, an embodiment of a transcript review interface 700 is shown. The illustrated interface represents a core component of the AI-assisted content compliance system, enabling reviewers to inspect transcribed content alongside audio playback and to interact with flagged content compliance issues. In the embodiment depicted, the transcript review interface 700 is shown with the Transcript tab 711 selected from the navigation bar 710, which enables the reviewer to toggle between various review stages such as Summary, Review, History, Notes, and Edit Submission.

The interface 700 includes a media playback panel 720, a transcript display panel 730, and a violation review panel 740. These panels are designed to operate in a coordinated manner, providing both live and asynchronous interaction with submitted digital content. The playback panel 720 includes an embedded media player configured to support audio or video content playback. In the illustrated embodiment, the player is configured as an audio player, but the system may support expanded views or alternative configurations for video content. The media player provides a play/pause control, a timestamp and duration display, a playback slider for seeking within the file, a volume control icon, and an overflow menu icon for user preferences such as playback speed or accessibility settings. An expansion control may also be provided to enlarge or reposition the media player as needed.

The transcript panel 730 displays a time-aligned transcript of the digital content, enabling the reviewer to view and scroll through the text in parallel with the audio. The reviewer also has the option to edit the transcript to correct punctuation, spelling, and/or deletion/insertion of words the AI model that did the transcription interpreted incorrectly. In some embodiments, the transcription text is dynamically highlighted in synchronization with the current audio playback location. The panel may also include timestamp indicators, static or dynamic date/time stamps 732, and an optional dropdown for navigating directly to specific flagged content segments.

A synchronization control 734 is also depicted in the header of the transcript panel. This control includes a set of selectable options configured to manage the synchronization behavior between audio and transcript. In one embodiment, a first option (e.g., a line with a single upward arrow) allows the user to scroll the transcript independently while snapping the playback to the current transcript segment when selected. A second option (e.g., a line with bi-directional arrows) may enable continuous synchronization between playback and transcript position, allowing both to update in tandem as playback progresses. A third option (e.g., a power button icon) may be configured to temporarily disable synchronization, granting the reviewer full manual control over transcript navigation. These options provide flexible interaction paradigms suited to different review workflows and user preferences.

The transcript panel 730 may further include a language selector 736, which allows the reviewer to toggle between an original and a translated version of the transcript when translation model has been invoked. This feature facilitates multilingual review by enabling language-specific analysis. Additional header controls may include buttons for jumping to the start or end of the transcript, enlarging the transcript display, or switching between display modes.

In the illustrated embodiment, the main text body 738 of the transcript panel presents a scrollable view of the transcribed content, with potential content compliance violations highlighted using visual indicators such as color changes, bold formatting, or underlining. These highlights are linked to underlying model outputs or reviewer inputs and may correspond to specific violation entries in the adjacent violation review panel 740.

The violation panel 740 is configured to display content compliance issues identified by AI models, human reviewers, or both. The panel is subdivided into selectable filter tabs, including All, Rule Violations 742, Keywords, and Music. Selecting a tab filters the list of displayed issues accordingly. A search bar 744 is provided to permit keyword-based filtering within the selected category.

Within the body of the panel 740, each identified issue is listed with a corresponding timestamp, optionally a content excerpt, rule violation explanation, and origin indicator (e.g., AI-generated or human-added). Reviewers may select an entry to automatically scroll the transcript panel 730 to the relevant location and synchronize playback to the associated timestamp. Each violation entry includes interface elements 746 such as a thumbs-up icon, a thumbs-down icon, and an edit icon. These allow the reviewer to affirm, reject, or modify the flagged violation. A toggle 748 is also provided to show or hide previously rejected issues.

In the example shown, one violation has been flagged as making an unsubstantiated product performance claim. This is displayed with contextual justification and has been approved by the reviewer via the thumbs-up control. In particular, a highlighted text segment 747 within the transcript panel 730 corresponds to the selected violation and visually emphasizes the relevant portion of the content under review. Reviewers may also edit the violation explanation using the edit button to refine or add commentary for downstream review, training, or audit purposes.

The transcript review interface 700 serves as a central workspace where reviewer decisions, system-generated flags, and synchronized content presentation converge. In some embodiments, the system may support voice-based annotations, contextual tagging, or multi-language overlays within this interface. Reviewer actions taken in this view may be logged to the reviewer feedback system 232D, used to refine compliance classification models or other models, or stored in the data repository 244 for auditing and downstream analytics.

Although specific controls and layout options are illustrated in FIG. 7, alternative embodiments may include additional features, dynamic widgets, or personalized layouts based on reviewer preferences, institutional policy, or content format which can be saved for the user and retained for future sessions by that user. The interface may also be deployed in responsive configurations suitable for different device types or integrated within larger content governance platforms.

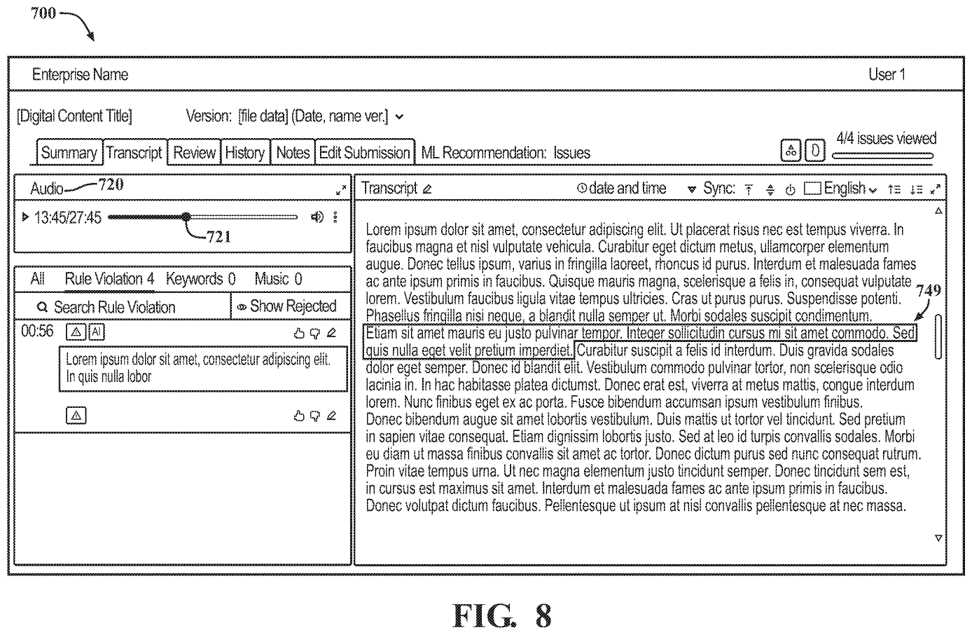

Referring now to FIG. 8, an embodiment of the transcript review interface 700 is shown with emphasis on synchronized highlighting and audio navigation. In this view, the media playback panel 720 includes a visible playback slider 721 positioned partway through the duration of the audio file, allowing the reviewer to seek to a specific point in time. This visual element reinforces the time-aligned nature of the transcript display panel 730.

As illustrated, the transcript panel 730 includes a highlight 749 indicating the text segment aligned with the current audio playback location. In the depicted view, this highlighting reflects live synchronization between the playback slider 721 and the transcribed text but does not depict any concurrently selected content compliance violation. In embodiments where a content violation is selected, a separate highlight 747 may be used to visually distinguish the associated portion of the transcript. Different styling cue such as color, weight, or underlining may be applied to differentiate synchronization-based highlighting from compliance-based annotations.

This playback-synchronized highlighting supports reviewer clarity by visually tracking the current position in the transcript relative to the audio content. When used in conjunction with the playback slider 721, this feature enables precise navigation and review, particularly in long-form or time-sensitive content. In some embodiments, the reviewer may adjust playback speed to facilitate faster or slower content consumption, and the transcript may scroll at a corresponding rate to match the altered playback tempo. The scrolling behavior of the transcript panel may be configured to center the active text segment within the visible pane, or to advance in a page-by-page manner that minimizes distraction. Even when no violations are actively selected, the synchronized highlighting and scroll behavior together provide meaningful context to assist the reviewer in understanding the cadence, progression, and tone of the digital content.

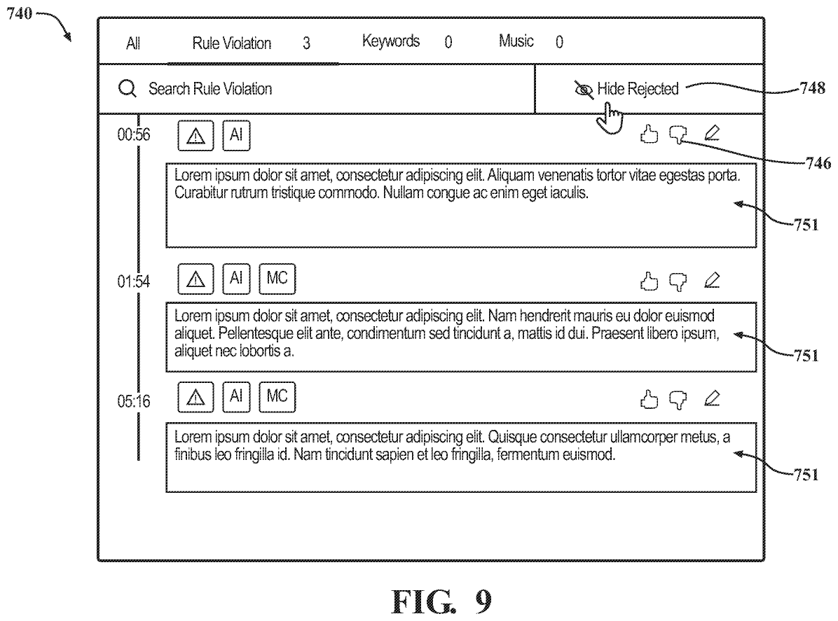

Referring now to FIG. 9, an enlarged view of a violation review panel 740 is illustrated. This view emphasizes how multiple content compliance violations are displayed, reviewed, and adjudicated by a human reviewer, particularly in embodiments where rejected violations are visible. The depicted embodiment corresponds to a configuration in which the Show Rejected toggle 748 is active, causing previously rejected violations to remain visible within the panel alongside accepted entries.

Each row in the violation panel corresponds to a distinct flagged issue, organized chronologically by timestamp. For example, entries are shown at timestamps 00:56, 01:54, and 05:16, each representing the point in the digital content at which the identified violation occurs. Each violation is associated with one or more classification badges or source indicators—such as AI for artificial intelligence-generated flags and MC for manual classification or human-injected annotations. These tags allow reviewers to understand the provenance of the violation and to evaluate credibility or context accordingly.

In this embodiment, each violation entry includes a brief natural language description explaining the rationale behind the flag 751. These may reference concerns such as unsubstantiated product performance claims, misleading health-related assertions, overly broad guarantee language, or any other violation of applicable business rules compliance standards. In some cases, entries may cite the specific language used or the inferred implication that triggered the classification.

Each violation entry is presented with a reviewer control cluster 746, which includes a thumbs-up icon for approval, a thumbs-down icon for rejection, and an edit icon for modifying or annotating the entry. As shown, some violations have been affirmed (thumbs-up), while others have been explicitly rejected (thumbs-down), illustrating the simplicity and flexibility of reviewer input and system feedback handling. The inclusion of the edit control allows the reviewer to revise the machine-generated description, add contextual comments, or correct inaccuracies before finalizing the violation determination.

This interface design supports efficient quality control over flagged content issues by visually grouping similar violations, presenting concise justification text, and exposing reviewer actions at a glance. In some embodiments, additional filters, batch operations, or tagging features may be layered on top of this core view to support higher-volume workflows or specialized reviewer roles.

Although the illustrated embodiment includes rule violations related to earnings and lifestyle claims, the violation panel 740 may accommodate a broad range of content types, rule sets, or risk classifications depending on regulatory frameworks or organizational guidelines. The visibility of rejected issues further enhances transparency, auditability, and training value. This is particularly true in embodiments where reviewer disagreement is used to calibrate or retrain compliance models downstream.

In some embodiments, the content compliance detection model includes a compliance classification model configured to classify statements in the transcribed digital content using a hierarchical classification structure. This structure may include:

Higher-level compliance categories corresponding to general thematic groupings of content to which content compliance rules are applicable, such as: business environment classification, opportunity positioning classification, provider positioning classification, business building classification, product claims classification, event classification, and administrative classification.

For each higher-level category, one or more lower-level classifications corresponding to specific types of content compliance violations, such as: product performance misrepresentation classification, unauthorized health claim classification, disparaging classification, offensive classification, business model mischaracterization classification, guarantee classification, non-optional classification, extraordinary earning classification, and extraordinary lifestyle classification.

In some implementations, the classification hierarchy further includes middle-level compliance categories positioned between the higher-level and lower-level classifications. These may include, for example: opportunity description classification, prospecting classification, provider participation classification, imbalanced business classification, facts and figures classification, earning discussion classification, time classification, and effort classification.

The classification structure may be stored as a mapping between compliance rule identifiers and classification levels. The system may apply these mappings to structure violation displays in the reviewer interface, support tagging in violation descriptions, or generate training labels for supervised learning of classification models. In some embodiments, the hierarchical classification structure is generated based on historical compliance review data comprising previously reviewed digital content labeled with confirmed content compliance violations, and the compliance classification model is trained on such labeled data to associate transcribed content with the corresponding higher-, middle-, and lower-level classifications.

The structure may be updated over time based on reviewer feedback, including approvals, rejections, and edited justifications. These updates may be incorporated into subsequent versions of the classification model to refine accuracy and consistency across deployments. In this way, the hierarchical classification structure not only supports model interpretability and traceability but also allows the system to evolve dynamically through human-in-the-loop feedback and policy refinement.

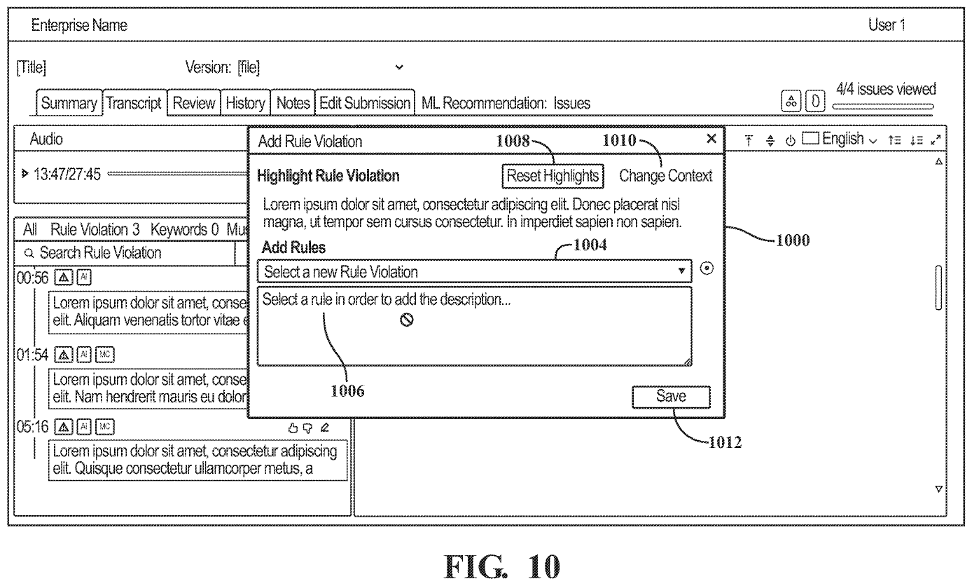

Referring now to FIG. 10, an embodiment of a manual violation entry interface 1000 is shown. This interface is presented as a modal pop-up window within the reviewer interface 240, triggered when a reviewer selects a segment of transcribed text and activates an Add Rule Violation control from the transcript panel 730. The manual violation entry interface 1000 enables human reviewers to insert new content compliance violations that may not have been identified by the automated classification system.

In the illustrated embodiment, the interface includes a highlighted preview of the selected transcript segment 1002, corresponding to the portion of digital content the reviewer wishes to flag. This selection remains visible throughout the manual entry process to provide textual context for the violation being reported.

Below the highlight, an Add Rules section is provided. A dropdown selector 1004 enables the reviewer to select from a predefined set of content compliance rule violations. This dropdown may reflect the hierarchical classification structure described herein, allowing the user to select from higher-level categories and drill into middle-level and lower-level rule identifiers. In some embodiments, selecting a rule from the dropdown may auto-populate a rationale template or recommended language into the description box 1006.

The description box 1006 provides a free-text input field in which the reviewer can articulate the reasoning for the flag. This may include paraphrased summaries of the issue, citation of non-compliant language, or commentary supporting the rule selection. In some embodiments, standardized language options or quick-insert justifications may be provided to accelerate review workflows and promote consistency across reviewers.

A Reset Highlights button 1008 is provided to allow the reviewer to clear the currently selected transcript segment and make a new selection if the wrong portion was highlighted. A Change Context control 1010 is also shown. In some embodiments, the Change Context control may permit the reviewer to switch the view or scope of the violation entry—for example, by toggling between speakers, selecting a different section of the transcript, or associating the violation with a different timestamp or media type. This functionality may be particularly useful for long-form or multimedia submissions in which the relevant compliance issue spans multiple segments or where the initial highlight does not reflect the full context of the violation.

Once the violation rule and rationale have been entered, the reviewer may activate a Save button 1012 to persist the manually added violation into the violation panel 740. The new violation may be visually marked as reviewer-added (e.g., with an MC badge) and may be treated as training input for future versions of the compliance classification model, especially in embodiments configured for continuous learning from reviewer feedback.

The manual violation entry interface 1000 enhances the flexibility and human oversight capabilities of the content compliance system by allowing reviewers to supplement machine-generated findings. It ensures that nuanced, contextual, or emerging risks can still be captured even if not previously represented in the training dataset. The structured form also ensures that manually added violations remain consistently formatted and auditable, supporting traceability and downstream analytics.

Although the illustrated embodiment provides dropdown-based rule selection and free-text rationale entry, alternative implementations may support predictive suggestions, classification tagging via voice input, or incorporation of metadata to link the violation to applicable business rules, regional standards, or content types. This extensible structure supports alignment with the hierarchical classification structure, enabling full traceability from manual reviewer action to classification schema and compliance training workflows.

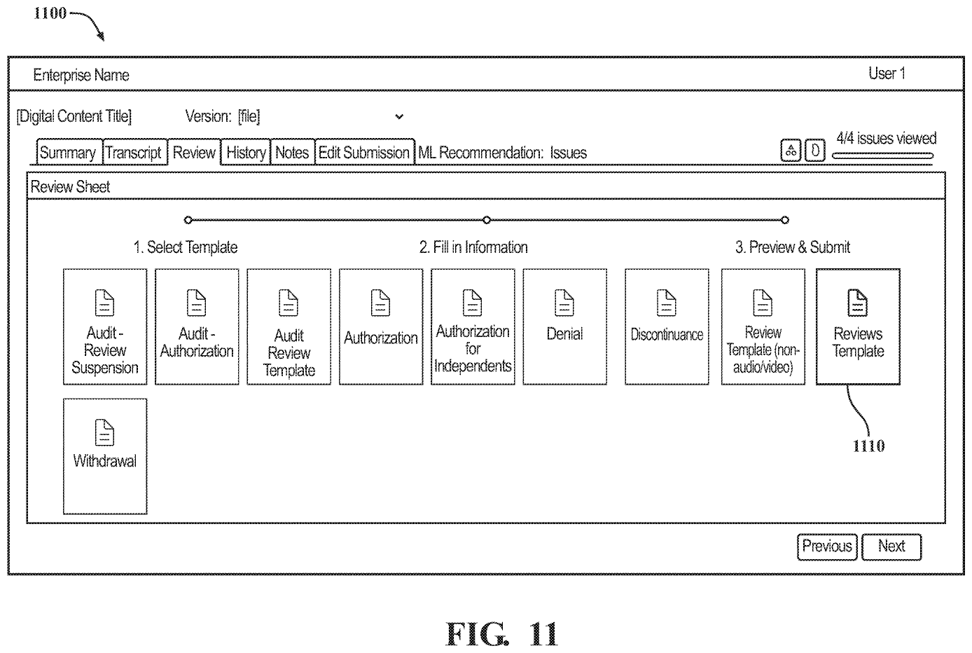

Referring now to FIG. 11, a communication template selection interface 1100 is illustrated. In the embodiment shown, this interface appears as part of the Review tab workflow and is used by reviewers to generate outbound communications to the content submitter following completion of the compliance review process. These communications may include approvals, rejections, requests for clarification, or other feedback depending on the outcome of the review.

The communication interface 1100 follows a structured three-step workflow comprising: (1) template selection, (2) information entry, and (3) preview and submission. In the illustrated embodiment, step one is active, and the user is presented with a series of predefined templates. These templates are configured to represent common types of review outcomes and correspondence formats. Examples include Audit—Review Suspension, Audit—Authorization, Audit Review Template, Authorization, Authorization for Independents, Denial, Discontinuance, Review Template (non-audio/video), and a default Reviews Template 1110, which is highlighted in the active state.

These templates may be populated with dynamic content and metadata associated with the submission under review, including submitter name, submission date, associated approved provider, identified violations, reviewer commentary, and decision outcomes. In some embodiments, the templates are generated using a document automation engine and support conditional formatting, merge fields, and context-aware explanations based on the rule violations or metadata associated with the submission.

The system may be configured such that the default Reviews Template 1110 is automatically selected in standard use cases, but alternative templates can be chosen where a more specialized communication is warranted—such as when issuing a denial, discontinuation, or authorization notice. In some embodiments, these templates are also associated with system-generated tracking identifiers or audit trails to ensure that the reviewer communications are stored and traceable for compliance purposes.

Once a template is selected, the system progresses to the information entry step, during which the reviewer may modify template content, insert specific comments, or select pre-defined responses based on the identified rule violations or reviewer recommendations. This design streamlines the generation of reviewer communications while preserving flexibility for customization and legal review where appropriate.

Although a specific set of templates is shown in FIG. 11, it should be understood that the template library may be modified, localized, or extended depending on regulatory context, enterprise branding, or jurisdictional requirements. Templates may be authored in advance by compliance personnel and updated periodically.

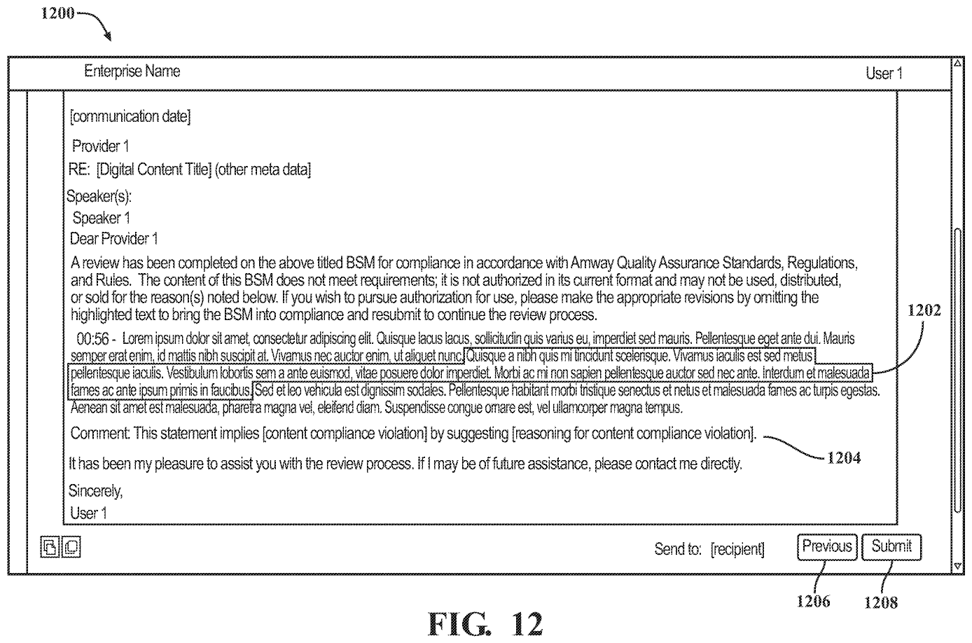

Referring now to FIG. 12, an example reviewer communication 1200 is illustrated, generated using the Reviews Template previously selected in FIG. 11. In the illustrated embodiment, the system has populated a draft review communication addressed to the content submitter based on reviewer inputs and system-generated content compliance findings. This communication is configured to advise the submitter of identified issues, explain the basis for non-authorization, and provide instructions for bringing the submission into compliance.

The communication includes metadata such as the review date, the reference code for the submission (Apply Code 349), the BSM title (“It's In Your Control”), and the listed speaker. The header also references the content's self-certified status and the corresponding BSM submission date.

A narrative explanation follows, generated by the compliance system in response to the reviewer's validation of one or more flagged violations. The message indicates that the BSM does not meet applicable quality assurance standards, regulations, and rules, and that it cannot be authorized in its current form. To facilitate corrective action, the reviewer communication specifies that the submitter should make revisions by omitting the highlighted text shown below from the digital content.

In some embodiments, the system may further facilitate future review workflows by comparing revised submissions against previously reviewed versions. When a submitter resubmits digital content after removing the highlighted portions identified in a prior review, the system may perform a binary or segment-level comparison of the new media file against the originally flagged version. If the system determines that the flagged segment has been effectively removed or replaced with non-substantially similar content, it may bypass full content reanalysis and instead trigger an expedited validation workflow. This may involve verifying only the modified sections or confirming the absence of previously noncompliant elements. Such an approach supports increased efficiency in iterative review scenarios, reduces redundant transcription and classification model execution, and enables more responsive content governance at scale. In some cases, this comparison may be performed on raw media signatures (e.g., hashed audio segments or content fingerprints), while in others, transcription or timestamp-aligned metadata may be used to localize and evaluate the differences.

In alternative embodiments, where the digital content has been re-recorded or otherwise materially altered such that direct binary or segment-level comparison of the media file is infeasible, the system may perform a differential review using transcription-based analysis. In such cases, the resubmitted content is transcribed and compared against the prior reviewed transcript to identify substantive changes in the linguistic content. If the system determines that the segment corresponding to the previously flagged content has been significantly modified or omitted, and no new violations are detected in its place, the system may streamline the review process by bypassing full manual inspection. This transcript-level comparison may leverage natural language difference detection, embedding-based similarity scoring, or segment alignment tools to localize changes. In some embodiments, a reviewer may be prompted to confirm the absence of the previously flagged language using a targeted review interface highlighting only changed or removed portions. This approach supports flexible yet efficient re-review workflows when submitters opt to redo portions of the content rather than simply remove flagged segments.

In the illustrated embodiment, the system provides a time-aligned excerpt of the transcribed content, with the relevant portion highlighted 1202 to indicate the specific segment identified as potentially non-compliant. A reviewer comment 1204 is provided immediately below the excerpt, articulating the compliance concern and reasoning in natural language. The flagged segment may relate to any applicable business rules compliance issue, such as an unsubstantiated product performance claim, misleading guarantee language, improper promotional phrasing, or other organization-specific standards derived from applicable business policies. The rationale may be generated by the system, reviewed and modified by a human reviewer, or authored entirely by the reviewer based on the context. This allows the system to support compliance determinations specific to business requirements, distinct from general-purpose content moderation approaches focused on profanity, violence, or community safety.

This structured output format of highlighted transcript segment plus contextual compliance rationale enhances reviewer transparency and submitter clarity. In some embodiments, multiple issues may be included in the same template with separate timestamps, highlights, and commentary sections.

The draft message may be further edited by the reviewer before final submission. Editable regions may include the explanation text, instructions for remediation, or the body of the accompanying email message. Upon finalization, the message may be submitted to the system for dispatch to the submitter via an integrated communication channel, as shown by the Send to field 1206 and Submit control 1208. In some embodiments, the system may store a copy of the communication for auditing, training, or dispute resolution purposes.

The illustrated embodiment emphasizes both the traceability and actionability of the content compliance review process. By combining system-generated annotations with reviewer-confirmed violations in a structured format, the system supports meaningful human oversight while ensuring that submitters receive clear and actionable guidance. This template-driven approach also ensures consistency across reviewers, even in high-volume or globally distributed compliance teams.

In some embodiments, the system may be configured to adapt content compliance detection logic based on jurisdictional or organizational compliance standards. For example, classification thresholds used to detect extraordinary earnings claims, lifestyle representations, or required participation may vary by country or region based on local consumer protection regulations or historical enforcement priorities. The system may implement rule evaluation thresholds, keyword sensitivities, or classifier parameters that are dynamically adjustable in accordance with geographic metadata associated with the submission or the identity of the submitting organization. This enables the platform to maintain consistent internal review standards while also supporting region-specific regulatory obligations across different compliance jurisdictions.

Additionally, the system may be configured to ingest and analyze diverse content types originating from social media platforms, livestream recordings, or short-form promotional media. In these embodiments, the digital content may include formats such as social video clips, live audio segments, interactive posts, or voiceovers embedded in multimedia content. The transcription, classification, and summarization models may be adapted to handle the structural characteristics of such content, including brief utterances, informal phrasing, or platform-specific linguistic conventions. This capability allows the system to extend its compliance evaluation beyond traditional business support materials (BSMs) to include emerging digital content channels increasingly used in brand representation and opportunity promotion.

In alternative embodiments, the system includes a user-facing self-help interface configured to enable content creators to receive preliminary compliance analysis prior to formal submission. The self-help tool may invoke the same or similar suite of machine learning models used in the formal review process, but deliver live (i.e., real-time or near real-time) automated feedback based on preliminary scoring against a compliance ruleset, automatically and without reviewer intervention or oversight. This functionality provides submitters with greater autonomy and allows them to iterate on their content before initiating formal review, ultimately improving the experience for both content creators and reviewers. In addition to supporting external content creators, the self-help interface may also be applied to internally generated marketing or promotional content, enabling proactive compliance validation during early development stages. In some implementations, the feedback may include suggested edits or highlight high-risk statements for revision.

The system may also support the use of segmented or customized compliance rule datasets, which can be referred to as segregated ground truth datasets, associated with specific entities, markets, or third-party licensees (e.g., Approved Providers). These datasets enable compliance evaluation tailored to unique linguistic, branding, or educational content standards while preserving the integrity of a core compliance ruleset shared across the organization. The processing system is configured to apply the appropriate dataset based on metadata attributes associated with the submission or user profile.

In further embodiments, the system is configured to ingest and analyze content originating from social media, podcasts, internal or external websites, and other digital platforms. These inputs may be handled using a combination of voice and image recognition models, keyword scanning, and structural parsing. Identified compliance violations may trigger internal alerts or external enforcement actions, including takedown requests or automated communication with third-party platforms via secure APIs.

The system may also include functionality for compiling content usage statistics, tracking compliance trends, identifying emerging terminology, and updating compliance rulesets accordingly. In some cases, outputs may include automated compliance communications, metadata-enriched reports, or enforcement triggers that are issued directly through integration with external systems.

In some embodiments, the system may include AI-assisted content modification capabilities, such as guided video or audio creation tools that align with compliance standards at the time of production. These tools may operate by dynamically referencing the ground truth dataset and associated classification models to ensure that user-generated content remains within compliant boundaries throughout stages of content development. The content generation tools may be used by both internal marketing teams and third-party content creators to improve the compliance profile of materials as they are created or revised.

In some implementations, these tools may provide automated revision workflows that assist with modifying flagged or non-compliant content. For example, upon identification of a violation, a basic version of the tool may simply remove or cut the violating portion from the media. In more advanced implementations, the system may assist users in generating revised content segments that preserve the tone, pacing, and messaging of the original material, while avoiding the identified compliance violation. Rather than requiring the submitter to manually recreate an entire segment, the system may offer tools that suggest alternative phrasing and enable efficient rerecording of only the relevant portion. In some embodiments, these tools may apply light post-processing—such as adjusting audio levels or trimming transitions—to help integrate the updated content smoothly into the existing file, while maintaining consistency with the original speaker's style and delivery. These revisions may be performed with full user visibility and control and are intended to streamline the editing process without obscuring or misrepresenting the identity or intent of the speaker.

In some embodiments, the system may present multiple revision options for a flagged segment—such as “cut only,” “cut and replace,” or “rewrite with explanation”—enabling users to select a preferred resolution path with minimal effort. These options may be presented via a guided interface, allowing users to preview and accept edits without requiring technical editing skills. This streamlined revision capability empowers content creators to resolve issues quickly and efficiently, improving compliance while preserving the integrity and intent of the original submission.

In yet other embodiments, rather than automatically modifying the digital content, the system may present an interactive editing interface that allows the content submitter to directly address flagged violations within the same environment. For example, upon identifying a problematic segment, the system may present a guided correction interface that displays the original content segment alongside a summary explanation of the issue—and, in some implementations, a machine-suggested revision. The interface may further provide a record button or similar input control, enabling the submitter to re-record or replace the flagged segment using their own device (e.g., microphone or webcam) without needing to exit the platform or engage separate editing tools.

In some embodiments, the system is configured to identify a suitable insertion point or boundary within the original content and to seamlessly merge the user-generated correction into the existing media file, preserving audio or video continuity. For instance, the system may apply smoothing techniques to blend the corrected segment into the surrounding content and may optionally normalize volume, tone, or visual transitions to minimize disruption. The result is a revised version of the digital content in which only the violating segment has been replaced, while the remainder of the content remains intact and unmodified.

This targeted correction workflow reduces the friction typically associated with iterative content review, and in some embodiments, may eliminate the need for full re-review. For example, if the previously flagged violation is addressed using the guided correction interface and the remainder of the content was previously approved, the system may mark the updated content as compliant without requiring further manual review or may route it through a lightweight verification process. This capability enables a significantly faster and less burdensome feedback loop, improving the compliance posture of submitted content while preserving efficiency for both content creators and compliance reviewers.

Unlike conventional content moderation systems that focus on general policy enforcement such as profanity, hate speech, or violence, the present system can be trained to evaluate digital content against proprietary business rule compliance standards. These standards can be defined by an organization-specific ground truth dataset and go beyond generic moderation to include nuanced compliance rules related to opportunity claims, provider conduct, and promotional messaging.

Prior to implementation of the present system, compliance review of business support materials was a predominantly manual process, requiring human reviewers to listen to entire audio recordings or view full video submissions in real-time, manually transcribe content, identify potential violations based on memory or reference checklists, and generate customized reviewer communications from scratch. This approach was time-consuming, inconsistent across reviewers, and prone to both over-and under-enforcement of applicable standards. By contrast, the present system automates large portions of this workflow—providing synchronized transcription, AI-generated summaries and flags, hierarchical classification of compliance issues, and reviewer-in-the-loop training mechanisms—thereby improving efficiency, consistency, and traceability across large volumes of digital content. This transformation enables organizations to apply a standardized, scalable, and auditable compliance framework that is not only more accurate, but also adaptable to evolving content formats and jurisdictional rules.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Furthermore, the particular features, structures, or characteristics may be combined in any suitable manner with or in one or more embodiments.

1. A system for assisted content compliance review of digital content comprising:
a digital content submission portal configured to receive digital content submissions from content submitters, wherein the digital content includes at least one of audio, video, and multimedia files;
a storage system configured to store the received digital content in memory;
a content compliance processing system including a content compliance processor and a plurality of different models, the content compliance processing system configured to assist content compliance review of the digital content by processing the digital content using the plurality of different models to automatically identify potential content compliance violations in the digital content, the plurality of different models including:
a transcription model configured to convert the digital content into transcribed digital content in a text-based format; and
a content compliance detection model configured to identify content compliance violations;
a reviewer interface configured to display automatically identified content compliance violations and associated portions of the transcribed digital content, the reviewer interface configured to receive reviewer feedback regarding the automatically identified content compliance violations, including confirmation or rejection of the automatically identified content compliance violations; and
a compliance enforcement system configured to generate and communicate compliance review results to the content submitters.

2. The system of claim 1, wherein the plurality of different models includes a translation model configured to translate the transcribed digital content into a different language.

3. The system of claim 1, wherein the content compliance detection model includes a compliance classification model to classify statements in the transcribed digital content, wherein the compliance classification model is configured to classify statements in the transcribed digital content using a hierarchical classification structure, the hierarchical classification structure comprising:
a plurality of higher-level compliance categories corresponding to general thematic groupings of content to which content compliance rules are applicable; and
for each higher-level compliance category, one or more lower-level classifications corresponding to specific types of content compliance violations.

4. The system of claim 3, wherein the hierarchical classification structure is generated based on historical compliance review data comprising previously reviewed digital content labeled with confirmed content compliance violations, and wherein the compliance classification model is trained using the labeled data to associate transcribed content with corresponding higher-level and lower-level classifications.

5. The system of claim 3, wherein the hierarchical classification structure is updated based on the reviewer feedback indicating whether automatically identified content compliance violations are confirmed or rejected, and wherein subsequent versions of the compliance classification model are trained using the updated structure to refine classification accuracy over time.

6. The system of claim 3, wherein the hierarchical classification structure comprises a mapping between compliance rule identifiers and classification levels, and wherein each classification level corresponds to a stored set of content compliance rules used to evaluate the transcribed digital content.

7. The system of claim 3, wherein the plurality of higher-level compliance categories includes two or more of: business environment classification, provider positioning classification, business building classification, and opportunity positioning classification.

8. The system of claim 3, wherein the plurality of lower-level compliance categories includes two or more business rule compliance classifications derived from organization-specific policies, including business model mischaracterization classification, guarantee classification, non-optional classification, extraordinary earning classification, extraordinary lifestyle classification, unsubstantiated product performance classification, and misleading promotional claim classification.

9. The system of claim 3, wherein the hierarchical classification structure comprises a set of middle-level compliance categories positioned between the higher-level compliance categories and the lower-level compliance classifications, the middle-level compliance categories including two or more of: opportunity description classification, prospecting classification, provider participation classification, imbalanced business classification, facts and figures classification, earning discussion classification, time classification, and effort classification.

10. The system of claim 1, wherein the plurality of different models of the content compliance processing system are implemented as machine learning models hosted on a cloud-based platform, and wherein the content compliance processing system is configured to interact with a model execution application programming interface to initiate execution of the machine learning models to access the stored digital content and identify content compliance rule violations based on the stored digital content.

11. The system of claim 10, wherein the reviewer feedback received by the reviewer interface is stored in a reviewer feedback system and used to update training data for refining subsequent versions of the machine learning models.

12. The system of claim 11, wherein the reviewer feedback includes narrative commentary describing a rationale for confirming or rejecting the automatically identified content compliance violations.

13. The system of claim 1, wherein the content compliance detection model includes a sentiment analysis model configured to classify sentiment of statements in the transcribed digital content, the classified sentiment being used to support identification of content compliance violations.

14. The system of claim 13, wherein sentiment classifications associated with exaggerated positivity, assertiveness, or urgency are weighted to increase the likelihood of detecting potential content compliance violations related to extraordinary earning claims, extraordinary lifestyle claims, or misleading promotional statements.

15. The system of claim 1, wherein the plurality of different models includes a summarization model configured to generate a summary of the transcribed digital content, the summary being presented via the reviewer interface to provide contextual information and to facilitate efficient confirmation or rejection of automatically identified content compliance violations.

16. The system of claim 1, wherein the compliance enforcement system is configured to trigger automated enforcement actions based on the content compliance review results.

17. The system of claim 1, wherein the compliance enforcement system is configured to generate predefined communication templates for notifying content submitters of content compliance violations.

18. The system of claim 1, comprising a compliance data repository configured to store historical compliance review results, including reviewer feedback, for use in trend analysis and refinement of content compliance processing models.

19. The system of claim 1, wherein the content compliance processing system is configured to assign confidence measurements to automatically identified content compliance violations based on classification certainty or model output features, and wherein the reviewer interface is configured to filter or prioritize display of the content compliance violations based on a confidence threshold.

20. The system of claim 1, wherein the reviewer interface is configured to receive a selection of a portion of the transcribed digital content and an associated new content compliance violation.

21. The system of claim 1, further comprising a self-help compliance feedback module configured to analyze submitted digital content and provide preliminary, automated feedback to content submitters regarding potential content compliance violations prior to formal review.

22. The system of claim 1, wherein the content compliance processing system is configured to access one or more segregated ground truth datasets, each corresponding to a particular content creator, market, or licensee, and apply the corresponding dataset to evaluate content compliance without altering a core compliance ruleset.

23. The system of claim 1, wherein the digital content includes content ingested from social media platforms, websites, podcasts, or livestreams, and wherein the system is configured to evaluate such content for compliance using transcription, visual recognition, and classification models.

24. The system of claim 1, further comprising a content generation assistance module configured to provide content creators with compliant content suggestions during content creation based on live evaluation against the ground truth dataset.

25.-48. (canceled)
